(19) United States
(12) Patent Application Publication
(10) Pub. No.: US 2021/0306153 A1
(43) Pub. Date: Sep. 30, 2021

(54) IDENTITY VERIFICATION METHOD AND COMPUTER DEVICE EMPLOYING THE SAME

(71) Applicant: HON HAI PRECISION INDUSTRY CO., LTD., New Taipei (TW)

(72) Inventors: YOUNG-WAY LIU, New Taipei (TW); CHENG-YOU HSIEH, New Taipei (TW); JUNG-YI LIN, New Taipei (TW)

(21) Appl. No.: 17/038,111

(22) Filed: Sep. 30, 2020

(30) Foreign Application Priority Data
Mar. 27, 2020 (CN) 202010230147.5

(51) Int. Cl. H04L 9/32; G06K 9/62

(52) U.S. Cl. CPC H04L 9/3231; H04L 2209/38; G06K 9/6215

(57) ABSTRACT

An identity verification method applied in a computer device includes periodically collecting biometric data of a user. A difference between the collected biometric data and pre-stored biometric data is determined. The pre-stored biometric data is updated to be the collected biometric data, and the collected biometric data and identification information of the user are uploaded to a blockchain when the difference is greater than a preset threshold. Once current biometric data of the user is obtained, and the identification information of the user from the blockchain based on the current biometric data of the user is downloaded, identity verification is performed on the user based on the downloaded identification information.

### FIELD

The present disclosure relates to identity verification technologies, in particular to an identity verification method and a computer device employing the same.

### BACKGROUND

Many fields involve identity verification. However, due to some reasons, such as an accident or a dementia, a user may forget identity information such as an ID number or an account password, and the user may not be able to complete the identity verification. Therefore, there is room to improve the current method of identity verification.

### BRIEF DESCRIPTION OF THE DRAWINGS

FIG. 1 is an architecture diagram of an application environment of an identity verification method provided by a preferred embodiment of the present disclosure.

FIG. 2 is a flowchart of the identity verification method provided by a preferred embodiment of the present disclosure.

FIG. 3 is a block diagram of an identity verification system provided by a preferred embodiment of the present disclosure.

FIG. 4 is a structural diagram of a computer device provided by a preferred embodiment of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

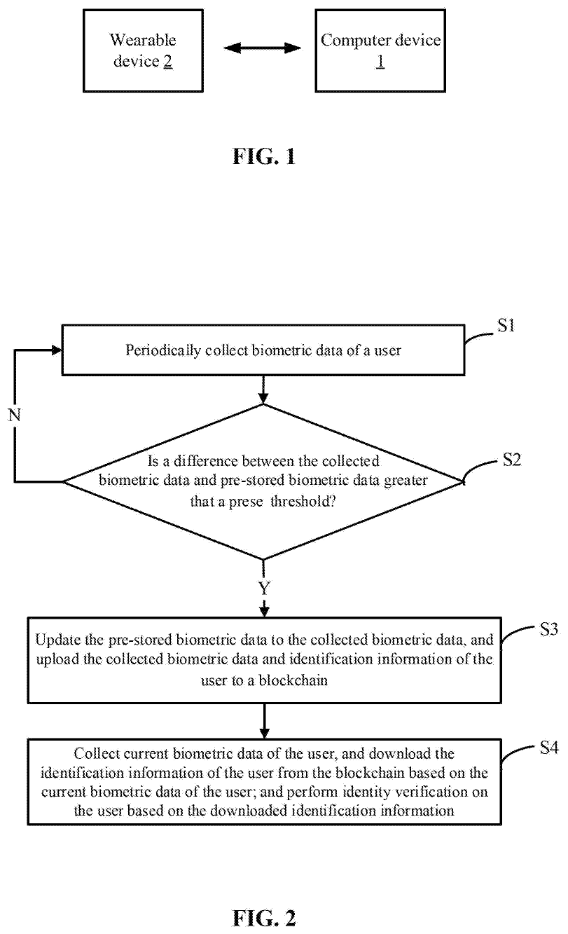

FIG. 1 illustrates an architecture diagram of an application environment of an identity verification method provided by a preferred embodiment of the present disclosure.

The identity verification method of the present disclosure is applied in an environment including a computer device 1 and one or more wearable devices 2.

In one embodiment, the computer device 1 may communicate with the wearable device 2 through a wired connection or a wireless connection. For example, the computer device 1 may communicate with the wearable device 2 through Bluetooth, WIFI, or Universal Serial Bus (USB).

In this embodiment, the computer device 1 may be a computer, a server, or a terminal device that needs to perform an identity verification on a user. In this embodiment, the identity verification may be performed when a user logs into the computer device 1, a user accesses a software installed in the computer device 1, or a user accesses predetermined data stored in the computer device 1.

In this embodiment, the wearable device 2 may be used to collect biometric data such as fingerprints, voiceprints, human faces, irises, heartbeats, and/or vein data such as vein images of a user. The wearable device 2 may be a smart bracelet, a patch-type sensing device that can be attached to the skin, a smart belt, smart clothes, or other microcomputer devices that can be worn or attached to the user.

Those skilled in the art should understand that the application environment is only for illustration, and should not be construed as limiting the present disclosure.

FIG. 2 is a flowchart of the identity verification method provided by a preferred embodiment of the present disclosure.

In this embodiment, the identity verification method can be applied to a computer device such as the computer device 1 shown in FIG. 4. For the computer device 1 that requires to perform the identity verification, the computer device 1 can be directly integrated with the function of performing identity verification. The computer device 1 can also achieve the function of performing identity verification by running a Software Development Kit (SDK).

FIG. 2 illustrates the flowchart of the method of identity verification.

At block S1, the computer device 1 periodically collects biometric data of a user.

In one embodiment, the computer device 1 can periodically (for example, every preset time, such as 10 days or half a month) collect the biometric data of the user by using the wearable device 2. As mentioned above, the wearable device 2 can be used to collect the biometric data such as fingerprints, voiceprints, human faces, irises, heartbeats, and/or vein data such as vein images of the user.

In one embodiment, the wearable device 2 can be a smart bracelet, a patch-type sensing device that can be attached to the skin of the user, a smart belt, smart clothes, and other microcomputer devices that can be worn or attached to the user.

At block S2, the computer device 1 determines a difference between the collected biometric data and pre-stored biometric data. When the difference is greater than a preset threshold, the process goes to block S3. When the difference is less than or equal to the preset threshold, the process goes back to block S1.

In this embodiment, the pre-stored biometric data is stored in the computer device 1 or in a cloud storage that is in communication with the computer device 1.

At block S3, when the difference is greater than the preset threshold, the computer device 1 updates the pre-stored biometric data to the collected biometric data, and uploads the collected biometric data and identification information of the user to a blockchain.

It should be noted that the updating the pre-stored biometric data to the collected biometric data can be defined to be replacing the pre-stored biometric data with the collected biometric data.

In one embodiment, when the difference is greater than the preset threshold, the computer device 1 issues a warning. The computer device 1 also turns off the warning in response to user's operation.

In one embodiment, the computer device 1 may display a dialog box on a display screen of the computer device 1. The computer device 1 determines that a current user of the wearable device 2 is a legal user when a confirmation signal from the dialog box is received. The computer device 1 turns off the warning when the current user of the wearable device 2 is the legal user.

In other embodiments, whether the current user of the wearable device 2 is the legal user can be manually confirmed.

In other embodiments, the computer device 1 may automatically recognize whether the current user of the wearable device 2 is the legal user.

Specifically, the computer device 1 may use the wearable device 2 to capture a face image of the current user of the wearable device 2 or the computer device 1 directly recognizes a human face of the current user of the wearable device 2. The computer device 1 then uses a face recognition algorithm to identify whether the current user of the wearable device 2 is the legal user using the captured image and a prestored face image. The face image of the legal user of the wearable device 2 is prestored in the computer device 1.

In other embodiments, when the difference is greater than the preset threshold, and the confirmation signal is received, the computer device 1 updates the pre-stored biometric data to the collected biometric data, and uploads the collected biometric data and the identification information of the user to the blockchain. That is, the updating the pre-stored biometric data to the collected biometric data, and the uploading the collected biometric data and the identification information of the user to the blockchain are performed in condition that the difference is greater than the preset threshold, and the confirmation signal that confirms the current user of the wearable device 2 is the legal user is received.

In one embodiment, the computer device 1 also pre-stores the identification information of the user of the wearable device 2.

In one embodiment, the identification information includes, but is not limited to, a name, an identity number, a communication address, an account number and a password for logging in to a predetermined application, of the user of the wearable device 2.

In one embodiment, the computer device 1 also uploads the collected biometric data of the user and the identification information of the user to the blockchain in advance.

In one embodiment, before uploading the collected biometric data of the user and the identification information of the user to the blockchain, the computer device 1 associates the collected biometric data of the user and the identification information of the user, and encrypts the collected biometric data of the user and the identification information of the user using a preset encryption algorithm (such as DES encryption algorithm). The computer device 1 then uploads the collected biometric data and the identification information of the user which have been associated to each other and have been encrypted, to the blockchain.

At block S4, when identity verification is required to be performed on the user, the computer device 1 collects current biometric data of the user, and downloads the identification information of the user from the blockchain based on the current biometric data of the user.

It should be noted that the “current biometric data” of the user can be defined to be the biometric data of the user collected when the identity verification is required to be performed on the user. Defining the “current biometric data” is for simply describing the present disclosure, such that the biometric data collected at block S4 can be distinct from the biometric data collected at block S1.

Specifically, when the identity verification needs to be performed on the user, the computer device 1 can collect the current biometric data of the user by using the wearable device 2. The computer device 1 also downloads the identification information of the user corresponding to the current biometric data of the user from the blockchain. Thus, the computer device 1 can perform the identity verification on the user based on the downloaded identification information.

It should be noted that, when the biometric data of the user and the identification information previously uploaded to the blockchain are encrypted, the computer device 1 decrypts the identification information after the identification information is downloaded.

In this embodiment, the identity verification is performed when the user logs in to the computer device 1, the user accesses a software installed on the computer device 1, and/or the user accesses predetermined data (e.g., a folder) stored in the computer device 1.

It should be noted that the present disclosure can obtain the identification information of the user for performing the identity verification based on the biometric data of the user, such that the user does not need to keep his/her own identification information in mind at all times.

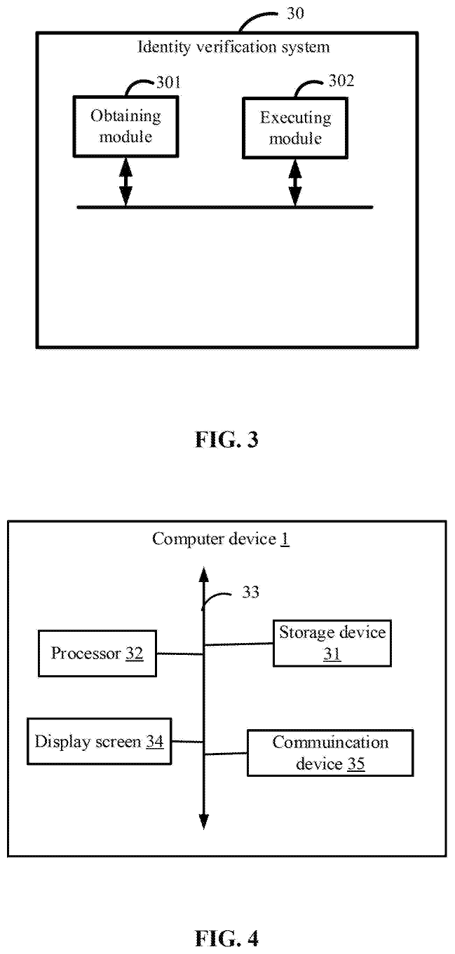

FIG. 3 shows an embodiment of modules of an identity verification system 30 of the present disclosure.

In some embodiments, the identity verification system 30 runs in a computer device (e.g., the computer device 1 in FIG. 4). The identity verification system 30 can include a plurality of modules. The plurality of modules can comprise computerized instructions in a form of one or more computer-readable programs that can be stored in a non-transitory computer-readable medium (e.g., a storage device 31 of the computer device 1 in FIG. 4), and executed by at least one processor of the computer device (e.g., a processor 32 of the computer device 1 in FIG. 4) to implement the identity verification function (described in detail in FIG. 2).

In at least one embodiment, the identity verification system 30 can include a plurality of modules. The plurality of modules can include, but is not limited to, an obtaining module 301 and an executing module 302. The modules 310-302 can comprise computerized instructions in the form of one or more computer-readable programs that can be stored in the non-transitory computer-readable medium (e.g., the storage device of the computer device), and executed by the at least one processor of the computer device to implement the identity verification function (e.g., described in detail in FIG. 1).

The obtaining module 301 periodically collects biometric data of a user.

In one embodiment, the obtaining module 301 can periodically (for example, every preset time, such as 10 days or half a month) collect the biometric data of the user by using the wearable device 2. As mentioned above, the wearable device 2 can be used to collect the biometric data such as fingerprints, voiceprints, human faces, irises, heartbeats, and/or vein data such as vein images of the user.

In one embodiment, the wearable device 2 can be a smart bracelet, a patch-type sensing device that can be attached to the skin of the user, a smart belt, smart clothes, and other microcomputer devices that can be worn or attached to the user.

The executing module 302 determines a difference between the collected biometric data and pre-stored biometric data. When the difference is less than or equal to a preset threshold, the obtaining module 301 periodically collects the biometric data of the user.

In this embodiment, the pre-stored biometric data is stored in the computer device 1 or in a cloud storage that is in communication with the computer device 1.

When the difference is greater than the preset threshold, the executing module 302 updates the pre-stored biometric data to the collected biometric data, and uploads the collected biometric data and identification information of the user to a blockchain.

It should be noted that the updating the pre-stored biometric data to the collected biometric data can be defined to be replacing the pre-stored biometric data with the collected biometric data.

In one embodiment, when the difference is greater than the preset threshold, the executing module 302 issues a warning. The executing module 302 also turns off the warning in response to user's operation.

In one embodiment, the executing module 302 may display a dialog box on a display screen of the computer device 1. The executing module 302 determines that a current user of the wearable device 2 is a legal user when a confirmation signal from the dialog box is received. The executing module 302 turns off the warning when the current user of the wearable device 2 is the legal user.

In other embodiments, whether the current user of the wearable device 2 is the legal user can be manually confirmed.

In other embodiments, the executing module 302 may automatically recognize whether the current user of the wearable device 2 is the legal user.

Specifically, the executing module 302 may use the wearable device 2 to capture a face image of the current user of the wearable device 2 or the executing module 302 directly recognizes a human face of the current user of the wearable device 2. The executing module 302 then uses a face recognition algorithm to identify whether the current user of the wearable device 2 is the legal user using the captured image and a prestored face image. The face image of the legal user of the wearable device 2 is prestored in the computer device 1.

In other embodiments, when the difference is greater than the preset threshold, and the confirmation signal is received, the executing module 302 updates the pre-stored biometric data to the collected biometric data, and uploads the collected biometric data and the identification information of the user to the blockchain. That is, the updating the pre-stored biometric data to the collected biometric data, and the uploading the collected biometric data and the identification information of the user to the blockchain are performed in condition that the difference is greater than the preset threshold, and the confirmation signal that confirms the current user of the wearable device 2 is the legal user is received.

In one embodiment, the executing module 302 also pre-stores the identification information of the user of the wearable device 2.

In one embodiment, the identification information includes, but is not limited to, a name, an identity number, a communication address, an account number and a password for logging in to a predetermined application, of the user of the wearable device 2.

In one embodiment, the executing module 302 also uploads the collected biometric data of the user and the identification information of the user to the blockchain in advance.

In one embodiment, before uploading the collected biometric data of the user and the identification information of the user to the blockchain, the executing module 302 associates the collected biometric data of the user and the identification information of the user, and encrypts the collected biometric data of the user and the identification information of the user using a preset encryption algorithm (such as DES encryption algorithm). The executing module 302 then uploads the collected biometric data and the identification information of the user which have been associated to each other and have been encrypted, to the blockchain.

When identity verification is required to be performed on the user, the executing module 302 collects current biometric data of the user, and downloads the identification information of the user from the blockchain based on the current biometric data of the user.

Specifically, when the identity verification needs to be performed on the user, the executing module 302 can collect the current biometric data of the user by using the wearable device 2. The executing module 302 also downloads the identification information of the user corresponding to the current biometric data of the user from the blockchain. Thus, the executing module 302 can perform the identity verification on the user based on the downloaded identification information.

It should be noted that, when the biometric data of the user and the identification information previously uploaded to the blockchain are encrypted, the executing module 302 decrypts the identification information after the identification information is downloaded.

In this embodiment, the identity verification is performed when the user logs in to the computer device 1, the user accesses a software installed on the computer device 1, and/or the user accesses predetermined data (e.g., a folder) stored in the computer device 1.

FIG. 4 shows one embodiment of a schematic structural diagram of the computer device 1. In an embodiment, the computer device 1 includes a storage device 31, at least one processor 32, at least one bus 33, a display screen 34, and a communication device 35. It should be understood by those skilled in the art that the structure of the computer device 1 shown in FIG. 4 does not constitute a limitation of the embodiment of the present disclosure. The computer device 1 may have a bus type structure or a star type structure, and the computer device 1 may further include other hardware or software, or the computer device 1 may have different component arrangements.

In one embodiment, the computer device 1 may communicate with the wearable device 2 through a wired connection or a wireless connection. For example, the computer device 1 may communicate with the wearable device 2 through Bluetooth, WIFI, or Universal Serial Bus (USB).

In this embodiment, the computer device 1 may be a computer, a server, or a terminal device that needs to perform an identity verification on a user. In this embodiment, the identity verification may be performed when a user logs into the computer device 1, a user accesses a software installed in the computer device 1, or a user accesses predetermined data stored in the computer device 1. In at least one embodiment, the computer device 1 can include a terminal that is capable of automatically performing numerical calculations and/or information processing in accordance with pre-set or stored instructions. The hardware of terminal can include, but is not limited to, a microprocessor, an application specific integrated circuit, programmable gate arrays, digital processors, and embedded devices.

It should be noted that the computer device 1 is merely an example, and other existing or future electronic products may be included in the scope of the present disclosure, and are included in the reference.

In some embodiments, the storage device 31 can be used to store program codes of computer readable programs and various data, such as the identity verification system 30 installed in the computer device 1, and automatically access to the programs or data with high speed during running of the computer device 1. The storage device 31 can include a read-only memory (ROM), a programmable read-only memory (PROM), an erasable programmable read only memory (EPROM), an one-time programmable read-only memory (OTPROM), an electronically-erasable programmable read-only memory (EEPROM), a compact disc read-only memory (CD-ROM), or other optical disk storage, magnetic disk storage, magnetic tape storage, or any other storage medium readable by the computer device 1 that can be used to carry or store data.

In some embodiments, the at least one processor 32 may be composed of an integrated circuit, for example, may be composed of a single packaged integrated circuit, or may be composed of multiple integrated circuits of same function or different functions. The at least one processor 32 can include one or more central processing units (CPU), a microprocessor, a digital processing chip, a graphics processor, and various control chips. The at least one processor 32 is a control unit of the computer device 1, which connects various components of the computer device 1 using various interfaces and lines. By running or executing a computer program or modules stored in the storage device 31, and by invoking the data stored in the storage device 31, the at least one processor 32 can perform various functions of the computer device 1 and process data of the computer device 1. For example, the function of performing the identity verification.

In some embodiments, the at least one bus 33 is used to achieve communication between the storage device 31 and the at least one processor 32, and other components of the computer device 1.

The display screen 34 may be a touch display screen. The communication device 35 may be a Bluetooth module or a WIFI module.

Although not shown, the computer device 1 may further include a power supply (such as a battery) for powering various components. Preferably, the power supply may be logically connected to the at least one processor 32 through a power management device, thereby, the power management device manages functions such as charging, discharging, and power management. The power supply may include one or more a DC or AC power source, a recharging device, a power failure detection circuit, a power converter or inverter, a power status indicator, and the like. The computer device 1 may further include various sensors, and details are not described herein.

In at least one embodiment, as shown in FIG. 3, the at least one processor 32 can execute various types of applications (such as the identity verification system 30) installed in the computer device 1, program codes, and the like. For example, the at least one processor 32 can execute the modules 301-302 of the identity verification system 30.

In at least one embodiment, the storage device 31 stores program codes. The at least one processor 32 can invoke the program codes stored in the storage device 31 to perform functions. For example, the modules 301-302 described in FIG. 3 are program codes stored in the storage device 31 and executed by the at least one processor 32, to implement the functions of the various modules for the purpose of performing identity verification.

In at least one embodiment, the storage device 31 stores one or more instructions (i.e., at least one instruction) that are executed by the at least one processor 32 to achieve the purpose of performing identity verification.

In at least one embodiment, the at least one processor 32 can execute the at least one instruction stored in the storage device 31 to perform the operations of as shown in FIG. 2.

The steps in the method of the embodiments of the present disclosure may be sequentially adjusted, merged, and deleted according to actual needs.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. An identity verification method applied to a computer device, the method comprising:
periodically collecting biometric data of a user;
determining a difference between the collected biometric data and pre-stored biometric data;
updating the pre-stored biometric data to the collected biometric data, and uploading the collected biometric data and identification information of the user to a blockchain, in condition that the difference is greater than a preset threshold;
collecting current biometric data of the user, and downloading the identification information of the user from the blockchain based on the current biometric data of the user; and
performing identity verification on the user based on the downloaded identification information.

2. The method as claimed in claim 1, wherein the biometric data comprises fingerprints, voiceprints, human faces, irises, heartbeats, vein data of the user, and/or a combination thereof.

3. The method as claimed in claim 1, wherein the biometric data of the user is collected using a wearable device.

4. The method as claimed in claim 1, further comprising:
issuing a warning when the difference is greater than the preset threshold; and
turning off the warning in response to user's operation.

5. The method as claimed in claim 1, wherein the identification information comprises a name, an identity number, a communication address, an account number and a password for logging in to a predetermined application, of the user of a wearable device.

6. The method as claimed in claim 1, wherein before uploading the collected biometric data and the identification information of the user to the blockchain, the method further comprises:
associating the collected biometric data of the user and the identification information of the user; and
encrypting the collected biometric data of the user and the identification information of the user using a preset encryption algorithm.

7. A computer device comprising:
a storage device; and
at least one processor;
the storage device storing one or more programs, which when executed by the at least one processor, cause the at least one processor to:
periodically collect biometric data of a user;
determine a difference between the collected biometric data and pre-stored biometric data;
update the pre-stored biometric data to the collected biometric data, and upload the collected biometric data and identification information of the user to a blockchain, in condition that the difference is greater than a preset threshold;
collect current biometric data of the user, and download the identification information of the user from the blockchain based on the current biometric data of the user; and
perform identity verification on the user based on the downloaded identification information.

8. The computer device as claimed in claim 7, wherein the biometric data comprises fingerprints, voiceprints, human faces, irises, heartbeats, vein data of the user, and/or a combination thereof.

9. The computer device as claimed in claim 7, wherein the biometric data of the user is collected using a wearable device.

10. The computer device as claimed in claim 7, wherein the at least one processor is further caused to:
issue a warning when the difference is greater than the preset threshold; and
turn off the warning in response to user's operation.

11. The computer device as claimed in claim 7, wherein the identification information comprises a name, an identity number, a communication address, an account number and a password for logging in to a predetermined application, of the user of a wearable device.

12. The computer device as claimed in claim 7, wherein before uploading the collected biometric data and the identification information of the user to the blockchain, the at least one processor is further caused to:
associate the collected biometric data of the user and the identification information of the user; and
encrypt the collected biometric data of the user and the identification information of the user using a preset encryption algorithm.

13. A non-transitory storage medium having instructions stored thereon, when the instructions are executed by a processor of a computer device, the processor is configured to perform an identify verification method, wherein the method comprises:
periodically collecting biometric data of a user;
determining a difference between the collected biometric data and pre-stored biometric data;
updating the pre-stored biometric data to the collected biometric data, and uploading the collected biometric data and identification information of the user to a blockchain, in condition that the difference is greater than a preset threshold;
collecting current biometric data of the user, and downloading the identification information of the user from the blockchain based on the current biometric data of the user; and
performing identity verification on the user based on the downloaded identification information.

14. The non-transitory storage medium as claimed in claim 13, wherein the biometric data comprises fingerprints, voiceprints, human faces, irises, heartbeats, vein data of the user, and/or a combination thereof.

15. The non-transitory storage medium as claimed in claim 13, wherein the biometric data of the user is collected using a wearable device.

16. The non-transitory storage medium as claimed in claim 13, wherein the method further comprises:
issuing a warning when the difference is greater than the preset threshold; and
turning off the warning in response to user's operation.

17. The non-transitory storage medium as claimed in claim 13, wherein the identification information comprises a name, an identity number, a communication address, an account number and a password for logging in to a predetermined application, of the user of the wearable device.

18. The non-transitory storage medium as claimed in claim 13, wherein before uploading the collected biometric data and the identification information of the user to the blockchain, the method further comprises:
associating the collected biometric data of the user and the identification information of the user; and
encrypting the collected biometric data of the user and the identification information of the user using a preset encryption algorithm.
